(19) United States
(12) Patent Application Publication
(10) Pub. No.: US 2013/0325432 A1
(43) Pub. Date: Dec. 5, 2013

(54) METHOD FOR ENABLING THE PLANNING OF A TREATMENT OF A TUMOUR USING A THERAPEUTIC VIRUS

(71) Applicants: Stephan Mittermeyer, Munich (DE); Eva Wembacher-Schroder, Essen (DE)

(72) Inventors: Stephan Mittermeyer, Munich (DE); Eva Wembacher-Schroder, Essen (DE)

(21) Appl. No.: 14/001,045

(22) PCT Filed: Mar. 18, 2011
(86) PCT No.: PCT/EP2011/054100

§ 371 Date: Aug. 22, 2013

(51) Int. Cl. G06F 19/00

(52) U.S. Cl. CPC G06F 19/3437
USPC 703/11

(57) ABSTRACT

A method for enabling the planning of a treatment of a tumour within a body using a therapeutic virus, wherein the virus distribution in the body is calculated by simulating the virus replication process, starting from an initial virus distribution, and the calculated virus distribution is provided for the planning.

The present invention relates to a method for enabling the planning of a treatment of a tumour within a body using a therapeutic virus.

Recently, a novel approach using therapeutic viruses has been considered for treating tumours. Such viruses act solely on tumour cells, for example by killing the cell, by stopping the cell from replicating or by revealing the cell to the immune system of the infected organism. The treatment of a tumour using a therapeutic virus has to be planned. For example, the location within the body at which the therapeutic virus is to be introduced and the amount and/or rate of the introduced therapeutic virus has to be planned, in particular optimised. The present invention relates to improving the planning of a treatment of a tumour using a therapeutic virus.

This goal is achieved by the subject-matter of any one of the appended independent claims. Advantages, advantageous features, advantageous embodiments and advantageous aspects of the present invention are disclosed in the following and contained in the subject-matter of the appended dependent claims. Different advantageous features can be combined in accordance with the invention wherever this is technically sensible and feasible.

In accordance with the present invention, a method for enabling the planning of a treatment of a tumour within a body using a therapeutic virus includes the steps of calculating the virus distribution in the body by simulating the virus replication process, starting from an initial virus distribution, and providing the calculated virus distribution in order to enable the planning.

As outlined above, a therapeutic virus exercises a specific effect on a tumour cell. In addition, the tumour cell is essential for the virus to replicate. When a virus hits a tumour cell, it penetrates the cell, i.e. it is internalised into the cell. The tumour cell is then modified such that it reproduces or replicates the virus, thereby generating copies of the virus. When the number of viruses within the cell becomes too large, the cell typically bursts and releases the replicated viruses which can then infect other tumour cells. This process is known as the lytic cycle.

In order for a treatment to be effective, a certain virus distribution in the body, in particular in the area of the body comprising the tumour, is necessary. This distribution is preferably a spatial distribution and represents for example the amount of virus particles in a certain volume of the body, either as an absolute value or in relation to other cells, preferably in relation to the number of tumour cells in the same volume. In this document, the term “virus” can mean a particular type of virus, such as an oncolytic virus tailored to a specific tumour, or a single virus particle, also referred to as a virion. The term “virus” as used throughout this document also encompasses viral vectors, which are used to place genetic material in the tumour cells.

The basic concept of the present invention is to calculate the virus distribution, which changes over time, in the body by simulating the virus replication process. The simulation starts from an initial virus distribution which can be simulated or measured. The initial virus distribution is typically a virus distribution after the virus has been injected, for example using a catheter.

The initial virus distribution can be measured, for example using MRT or MRI, in particular using a contrast agent which is injected together with the virus. Additionally or alternatively, the initial virus distribution can be simulated. In particular, the injection process of the virus can be simulated on the basis of at least one of: the structure of the tissue into which the virus is injected; the type of catheter; the injection duration; the injection flow rate; and the virus concentration in the injected agent. In particular, this simulation determines the initial virus distribution from a diffusion of the injected virus within the tissue. Alternatively, the initial virus distribution can be the virus distribution at an intermediate point in time during the replication process. This means that a calculated virus distribution is used as the initial virus distribution, for example in an iterative simulation.

The initial virus distribution is preferably represented by initial virus distribution data, and the virus distribution is preferably represented by virus distribution data. The calculated virus distribution data are preferably provided by outputting the virus distribution data to another piece of software or hardware, for example using a software interface or a hardware interface, respectively. In general, any kind of data are preferably stored in a data set, for example in a memory or on any kind of storage medium.

The virus replication process comprises at least a step of generating viruses from another virus, for example by the lytic cycle explained above. The virus replication process preferably comprises other steps such as propagating the (newly generated) viruses.

The replication process is preferably simulated using a stochastic model. In a first example, the stochastic model uses the tumour cell density and the virus density in a plurality of respective volumes into which at least a part of the body is divided. In this document, the term “body part” means at least a part of the body. The body part comprises at least a part of the tumour. In this example, the body part is divided into a plurality of volumes, in particular into a plurality of equally sized, cubic volumes. The volumes are preferably arranged in a three-dimensional array. Each volume typically comprises a certain amount of healthy body cells, tumour cells and viruses. The amount of tumour cells in each volume is the tumour cell density, and the amount of viruses in each volume is the virus density. The densities are given either as an absolute number or as a ratio as compared to either the total number of cells or the number of healthy cells in the volume. Another option is to provide the virus density as the number of viruses divided by the number of tumour cells. The tumour cell density is preferably represented by tumour cell density data, and the virus density is preferably represented by virus density data.

The number of tumour cells and the number of viruses in a particular volume is known or considered to be known at a certain point in time. The number of viruses within the volume at a later point in time can be calculated from statistical data, such as the probability of a virus being internalised into a tumour cell and the average number of viruses replicated in one tumour cell. To this end, the generation of new viruses is considered. The propagation of the viruses within a volume and therefore within the body can preferably then be predicted. This prediction can be used to determine whether a virus will remain within a particular volume or propagate into a neighbouring volume. Once the propagation has been predicted, in particular for all the volumes, the tumour cell densities and the virus densities in the volumes at a later point in time are known, and the replication of a virus can be further simulated. Virus generation and propagation are optionally simulated in a time-discrete manner. This means that all incidents, such as the bursting of cells, within a time frame are considered to take place at the same time. The propagation of the generated viruses is then simulated as if the movement of the viruses starts at this time.

In a second example, the stochastic model calculates the path of each virus and the probability of it penetrating a tumour cell along said path. As a result, the position of a tumour cell which is infected by the particular virus is known. The time the cell bursts and the number of replicated viruses in the tumour cell can then be calculated from statistical data on replication. The burst time and the number of released viruses can in particular be determined from a known statistical distribution. The path of a released virus and the probability of it penetrating a tumour cell along this path can then be calculated.

The stochastic model preferably utilises virus properties. Virus properties can include at least one of: probability of penetration; stability; time to replication; size; and stickiness. “Probability of penetration” means the probability that a virus will infect a tumour cell, i.e. will be internalised into the tumour cell. “Stability” means the life span of a virus, i.e. the time span between when the virus is generated or injected and when it dies. A virus is considered “dead” if it can no longer infect a tumour cell. Stability affects the propagation of the virus by limiting the length of a path the virus can travel. The stability is preferably represented by stability data. The probability of penetration as preferably represented by penetration probability data, for example an average probability of penetration.

“Size” means the size of the virus, which has an effect on the propagation of the virus within the body, in particular within the interstitial fluid. The size is preferably represented by size data. “Stickiness” means the virus' affinity for attaching itself to a cell, in particular a cell other than the tumour cell. Stickiness influences whether the virus reaches a tumour cell or whether it attaches to another cell beforehand. The stickiness is preferably represented by stickiness data. In general, a virus property can be described by a statistical distribution. The life time of a virus can for example be given as a curve representing the probability of a certain life time over the life time.

The stochastic model also preferably utilises patient-specific information including at least one of: age; body temperature; course of fibre tracts; and macroscopic cell structure. The patient-specific information is preferably represented by patient-specific information data. “Age” means the age of the body and influences cell activity and therefore the virus replication rate and the number of viruses generated before the cell bursts. The age is preferably represented by age data. Body temperature also influences virus replication, in particular the virus replication rate. The body temperature is preferably represented by body temperature data.

The macroscopic cell structure describes the types and arrangement of the cells, i.e. healthy and/or tumour cells, and preferably also the stroma. The stroma is the intercellular tissue. In a stochastic model according to Example 1, the macroscopic cell structure is preferably given for each volume. The macroscopic cell structure influences for example the propagation of the virus. In the stochastic model according to the first example, the basic assumption is that viruses in a particular volume spread evenly in all directions. However, depending on the macroscopic cell structure, propagation into one neighbouring volume may be more likely than into another neighbouring volume. The macroscopic cell structure can also be used to determine the path of a virus in the stochastic model according to the second example. The macroscopic cell structure is preferably represented by macroscopic cell structure data.

The method in accordance with the invention is in particular a data processing method. The data processing method is preferably performed using technical means, in particular a computer. The computer in particular comprises a processor and a memory in order to process the data, in particular electronically and/or optically. The calculating steps described are in particular performed by a computer. Determining or calculating steps are in particular steps of determining data within the framework of the technical data processing method, in particular within the framework of a program. A computer is in particular any kind of data processing device, in particular any kind of electronic data processing device. A computer can be a device which is generally thought of as such, for example desktop PCs, notebooks, netbooks, etc., but can also be any programmable apparatus, such as for example a mobile phone or an embedded processor. A computer can in particular comprise a system (network) of “sub-computers”, wherein each sub-computer represents a computer in its own right. A computer in particular comprises interfaces in order to receive or output data and/or perform an analogue-to-digital conversion. The data are in particular data which represent physical properties and/or are generated from technical signals. The technical signals are in particular generated by means of (technical) detection devices (such as for example devices for detecting marker devices) and/or (technical) analytical devices (such as for example devices for performing imaging methods), wherein the technical signals are in particular electrical or optical signals. The technical signals in particular represent the data received or outputted by the computer.

The invention also relates to a program which, when running on a computer or when loaded onto a computer, causes the computer to perform the any one of the aforementioned methods and/or to a program storage medium on which the program is stored (in particular in a non-transitory form) and/or to a computer on which the program is running or into the memory of which the program is loaded and/or to a signal wave, in particular a digital signal wave, carrying information which represents the program, in particular the aforementioned program, which in particular comprises code means which are adapted to perform all the steps of any one of the aforementioned methods.

Within the framework of the invention, computer program elements can be embodied by hardware and/or software (this includes firmware, resident software, micro-code, etc.). Within the framework of the invention, computer program elements can take the form of a computer program product which can be embodied by a computer-usable or computer-readable storage medium comprising computer-usable or computer-readable program instructions, “code” or a “computer program” embodied in said medium for use on or in connection with the instruction-executing system. Such a system can be a computer; a computer can be a data processing device comprising means for executing the computer program elements and/or the program in accordance with the invention. Within the framework of the present invention, a computer-usable or computer-readable medium can be any medium which can include, store, communicate, propagate or transport the program for use on or in connection with the instruction-executing system, apparatus or device. The computer-usable or computer-readable medium can for example be, but is not limited to, an electronic, magnetic, optical, electromagnetic, infrared or semiconductor system, apparatus or device or a medium of propagation such as for example the Internet. The computer-usable or computer-readable medium could even for example be paper or another suitable medium onto which the program is printed, since the program could be electronically captured, for example by optically scanning the paper or other suitable medium, and then compiled, interpreted or otherwise processed in a suitable manner. The computer program product and any software and/or hardware described here form the various means for performing the functions of the invention in the example embodiments. The computer and/or data processing device can in particular include a guidance information device which includes means for outputting guidance information. The guidance information can be outputted, for example to a user, visually by a visual indicating means (for example, a monitor and/or a lamp) and/or acoustically by an acoustic indicating means (for example, a loudspeaker and/or a digital speech output device) and/or tactilely by a tactile indicating means (for example, a vibrating element or vibration element incorporated into an instrument).

The present invention also relates to an apparatus comprising a computer on which the aforementioned program is running or into the memory of which said program is loaded.

It is within the scope of the present invention to combine one or more or all of the features of two or more examples or embodiments to form a new example or embodiment. In particular, features not essential to the invention can also be omitted from an example or embodiment.

The present invention shall be explained in more detail with reference to the accompanying drawings. These drawings show:

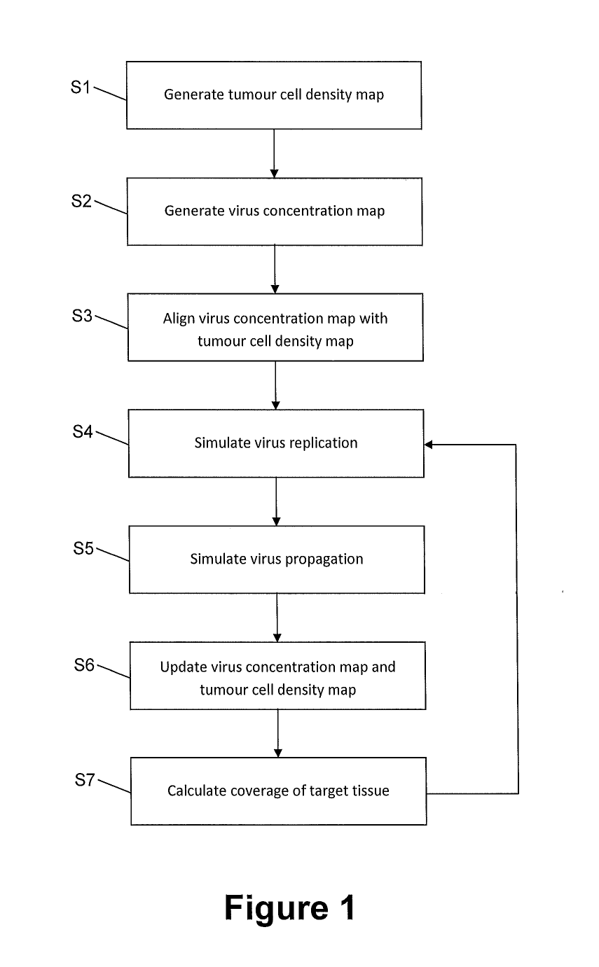

FIG. 1 a workflow for calculating the virus distribution;

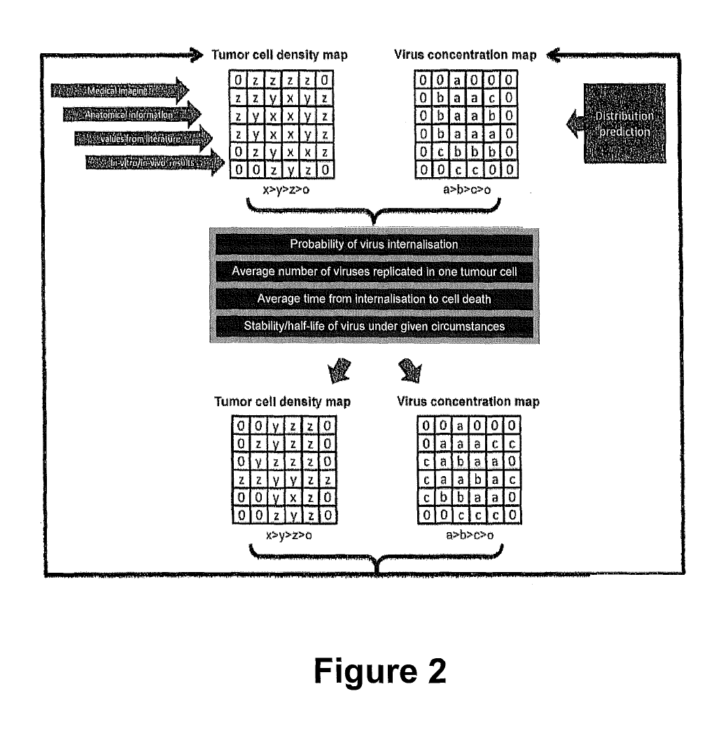

FIG. 2 the principle of simulating a virus replication process; and

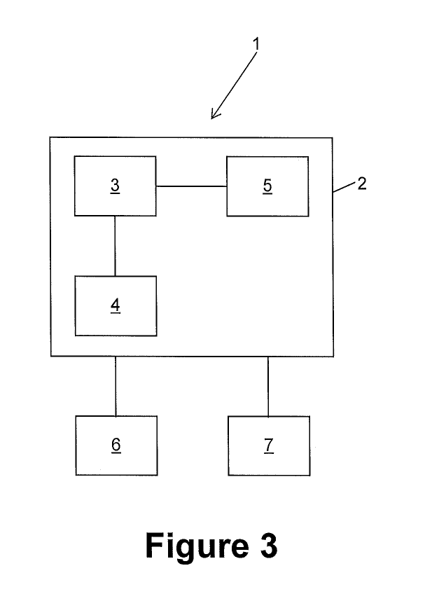

FIG. 3 an apparatus for carrying out the method of the invention.

FIG. 1 shows a workflow for calculating the distribution of a therapeutic virus within a body part in accordance with an embodiment of the method of the invention. The body part is at least a part of the body and comprises at least a part of a tumour.

In step S1, a tumour cell density map is generated. Within this context, the step of “generating” can mean actually determining the tumour cell density, for example using MRI (magnetic resonance imaging), or alternatively importing the tumour cell density map from another device or software module. The tumour cell density map is preferably a three-dimensional data set representing the tumour cell density in a plurality of respective volumes into which the body part is divided. The tumour cell density, i.e. information about the spatial distribution of the tumour cells at least in the body part or in the body, is preferably utilised in the simulation of the virus replication process.

In step S2, the virus concentration map is simulated. The simulation in step S2 is based on information about the structure of the body part into which the virus has previously been infused or is to be infused, the location of the infusion, the amount of virus infused and the infusion rate of the virus. Additional optional parameters include patient-specific information or virus properties such as those defined above. As an alternative to simulating, the virus concentration map can also be measured, for example using MRI. In general, the resulting virus concentration map represents an initial virus distribution of the therapeutic virus in at least the body part. The virus concentration map is preferably a three-dimensional data set.

In step S3, the virus concentration map generated in step S2 is aligned with the tumour cell density map of step S1, for example using rigid or elastic fusion. As a result, these two maps are then congruent with each other. The virus concentration map then represents the initial virus cell density in each of the plurality of volumes into which the body part is divided, i.e. the tumour cell density and the virus density is known for each volume.

In step S4, the virus replication is simulated. In this step, the number of generated viruses in each volume of the body part is calculated, as will be described in more detail below with reference to FIG. 2.

In step S5, the propagation of the viruses within the body part is simulated, i.e. predicted. In this step, the volumes of the body part into which the viruses within a particular volume spread is determined. It is essentially assumed that the viruses spread equally in all directions. However, depending on the structure of the neighbouring volumes, other distributions of the directions of virus propagation are possible.

In step S6, the virus concentration map and the tumour cell density map are updated. The updated virus concentration map represents the virus concentration, and the updated tumour cell density map the tumour cell density, in each volume after the replication and propagation of the virus have been simulated. Steps S5 to S7 together represent the simulation of the virus replication process.

In step S7, the coverage of the target tissue, i.e. the tumour, is calculated. This coverage is derived from the virus distribution and from the tumour cell distribution in the body part or, more generally, in the body. The coverage in particular represents whether or not the therapeutic virus has spread throughout the target tissue, i.e. the tumour, in a sufficient concentration. This is for example calculated by comparing the number of viruses in each volume with the number of tumour cells in the respective volume. The concentration may be considered to be sufficient if the number of viruses exceeds the number of tumour cells within each volume, for example by an absolute number or by a factor such as 2, 5, 10, 50 or 100.

If the coverage is sufficient, the workflow ends and the result of the simulation or information derived from the result of the simulation is provided for planning purposes. Derived information can for example be the coverage or the time the virus needs to spread sufficiently. If the coverage is not sufficient, then the workflow loops back to step S4 in order to perform a new iteration of the simulation.

One application of the present invention is to aid in planning a treatment of a tumour within the body. For this purpose, steps S2 to S7 of the workflow can be repeated with different initial virus distributions. Using the workflow, it is then possible to determine whether or not a particular initial virus distribution leads to a desired coverage of the target tissue. If this is the case, the time span needed for achieving this coverage can be determined. During planning, the initial virus distribution which exhibits the optimum, for example the shortest, time span between injecting the virus and achieving the desired coverage can accordingly be chosen.

The step of simulating the virus replication (step S4 in the workflow shown in FIG. 1) shall now be explained in more detail with reference to FIG. 2. The virus replication is simulated on the basis of the tumour cell density map TDM and the virus concentration map VCM. In FIG. 2, these maps are shown as two-dimensional arrays for the sake of simplicity. In practice, each map is typically a three-dimensional array of volumes into which the body part is divided.

In the maps, the value 0 indicates that the corresponding volume does not contain a tumour cell or a virus, respectively. In the tumour cell density map TDM, the variables x, y and z represent different tumour cell densities, where x>y>z>0. In the virus concentration map VCM, the variables a, b and c represent different virus concentrations, where a>b>c>0.

At the beginning of the workflow, the tumour cell density map is derived from medical imaging, anatomical information about the body, empirical values taken from literature, results from in-vitro or in-vivo measurements or any combination of these. The virus concentration map is either measured or simulated.

The two maps are provided to the central box in FIG. 2 which represents the simulation of the virus replication in step S4 and the simulation of the virus propagation in step S5. First, the probability of virus internalisation is used together with the tumour cell density and the virus concentration in each volume in order to determine the number of tumour cells in each volume which have been penetrated by a virus. This number is multiplied by the average number of viruses replicated in one tumour cell in order to determine the number of generated viruses in each volume. The amount of generated viruses over time can be determined from the average time between internalisation and cell death, i.e. the cell bursting. Instead of average values for the time and/or the number of replicated viruses, distribution functions can also be used.

Once the number of generated viruses in each volume has been calculated, the propagation of the generated viruses is simulated. This takes into account the distribution of the directions in which the viruses propagate, the speed of propagation and the stability or half-life of the viruses. “Stability or half-life” represents the time up until which a particular virus is capable of infecting a tumour cell. By incorporating this information, the virus concentration map represents the concentration of viruses which are still infective only.

The virus propagation is calculated from a certain spatial starting point. This starting point can be the centre of a volume for each virus in the volume. Alternatively, the starting points of the viruses can be distributed over the volume, for example uniformly. In another alternative, all the viruses generated by a particular tumour cell can have the same starting point, wherein the starting points, i.e. the locations of the burst tumour cells, are distributed over the volume, for example uniformly. Virus generation and propagation are preferably simulated for all the volumes, and the results combined. The simulation steps S4 and S5 result in an updated tumour cell density map and an updated virus concentration map.

Optionally, the tumour density is monitored after the actual infusion of the therapeutic virus. The monitored tumour cell density can be compared with the simulated density, for example once, repeatedly or continuously. Using this comparison, the parameters used in steps S4 and S5 can be updated. The updated parameters can be used to simulate the subsequent virus replication process within the body currently under treatment, or in subsequent applications of the method. In another option, advice information can be outputted which indicates that the infusion should be amended. The amendment can involve changing at least one of: the location of the infusion; the rate of the infusion; the total amount of viruses infused; or can involve performing an additional infusion at another location. Using multiple infusion locations is particularly useful if the body part comprises a barrier to the virus, such as necrotic tissue. It should be noted that the infusion process itself is not part of the present invention.

FIG. 3 shows an apparatus 1 for carrying out the method of the present invention. The apparatus 1 comprises a computer 2 which includes a calculating unit 3 on which a program which carries out the method according to the present invention is running. The computer 2 also comprises a memory 4, for example for storing the program and/or application data such as the virus distribution data or tumour cell density data. The apparatus 1 also comprises a display device 6, such as a monitor, for displaying information such as the tumour cell density map and/or the virus concentration map and in particular the changes in these maps over time. The display device 6 is connected to the computer 2. The computer 2 also comprises an interface 5 via which information such as the tumour cell density map or the virus concentration map is provided to the computer 2. The computer 2 can be connected via the interface 5 to a storage device which stores the data to be provided, or to another device such as an imaging apparatus for providing the data. The apparatus 1 also comprises an input device 7, such as a mouse and/or a keyboard, which is connected to the computer 2.

An adaptor can be used to assemble multiple parts of the apparatus 1 or to attach the apparatus 1 to another device. Such an adaptor is also part of the present invention. An adaptor for fixing a (medical) apparatus to one or two support structures is characterised in that the adaptor is constructed in three parts from a bearing part and two support parts, wherein the bearing part can be connected to the medical apparatus, the first support part can be connected to a first support structure, and the second support part can be connected to a second support structure, and wherein the adaptor can assume at least three states: a first state, in which the bearing part is connected, free of clearance, to the first support part only; a second state, in which the bearing part is connected, free of clearance, to the second support part only; and a third state, in which the bearing part is connected, free of clearance, to the first support part and the second support part.

1. A method for planning of a treatment of a tumour within a body using a therapeutic virus, comprising the steps of generating a tumour cell density map representing the tumour cell density in a plurality of respective cubic volumes into which a body part is divided, wherein the body part comprises at least a part of the tumour; generating a virus concentration map which represents an initial virus distribution of the therapeutic virus in at least the body part; aligning the virus concentration map with the tumour cell density map; simulating the virus replication by calculating the number of generated viruses in each volume of the body part; simulating the propagation of the viruses within the body part by determining the volumes of the body part into which the viruses within a particular volume spread; updating the virus concentration map and the tumour cell density map; calculating whether or not the therapeutic virus has spread throughout the tumour; and returning to the step of simulating the virus replication if this is not the case.

2. The method of claim 1, wherein the replication process is simulated using a stochastic model.

3. (canceled)

4. (canceled)

5. The method of claim 2, wherein the stochastic model calculates the path of each virus and the probability of it penetrating a tumour cell along said path.

6. The method of claim 2, wherein the stochastic model utilises virus properties.

7. The method of claim 6, wherein virus properties include at least one of: probability of penetration; stability; time to replication; size; and stickiness.

8. The method of claim 2, wherein the stochastic model utilises patient-specific information.

9. The method of claim 8, wherein patient-specific information includes at least one of: age; body temperature; course of fibre tracts; and cell structure.

10. The method of claim 1, wherein the initial virus distribution is simulated or measured.

11. The method of claim 1, wherein the method is a data processing method performed by a calculating unit, the virus distribution is represented by virus distribution data, and the initial virus distribution is represented by initial virus distribution data.

12. A program which, when running on a computer or when loaded onto a computer, causes the computer to perform the method according to claim 1, and/or a program storage medium on which the program is stored, and/or a signal wave, in particular a digital signal wave, carrying information which represents the program.

13. A computer on which the program according to claim 12 is running or into the memory of which said program is loaded.
